(19) United States
(12) Patent Application Publication
(10) Pub. No.: US 2015/0334333 A1
(43) Pub. Date: Nov. 19, 2015

(54) ELECTRONIC DEVICE AND METHOD FOR CONTROLLING THE SAME

(71) Applicant: Kabushiki Kaisha Toshiba, Tokyo (JP)

(72) Inventors: Kazuki Kuwahara, Saitama-shi (JP); Fumihiko Murakami, Yokohama-shi (JP); Hajime Suda, Hamura-shi (JP); Masami Tanaka, Ome-shi (JP)

(73) Assignee: KABUSHIKI KAISHA TOSHIBA, Tokyo (JP)

(21) Appl. No.: 14/276,710

(22) Filed: May 13, 2014

(51) Int. Cl. H04N 5/44; H04N 5/445; H04N 5/63

(52) U.S. Cl. CPC H04N 5/44; H04N 5/63; H04N 5/4403; H04N 5/44582

(57) ABSTRACT

According to one embodiment, an electronic device including a display configured to display video, a reception module configured to receive a video signal from a connected device, and a controller configured to perform a display process of displaying input video corresponding to the video signal received by the reception module in the video being displayed by the display.

### CROSS-REFERENCE TO RELATED APPLICATIONS

This application claims the benefit of U.S. Provisional Application No. 61/860,183, filed Jul. 30, 2013, the entire contents of which are incorporated herein by reference.

### FIELD

Embodiments described herein relate generally to an electronic device and a method for controlling the same.

### BACKGROUND

An electronic device is capable of transmitting a stream in compliance with standards such as a High-Definition Multimedia Interface (HDMI) and a Mobile High-Definition Link (MHL).

An electronic device (hereinafter referred to as a source apparatus) on the side that outputs a stream outputs a stream to an electronic device (hereinafter referred to as a sink apparatus) on the side that receives a stream. The source apparatus is capable of receiving a power supply from the sink apparatus (charging a built-in battery using the sink apparatus as a power source) when connected to the sink apparatus via a cable compatible with the MHL standard. The source apparatus and the sink apparatus connected via a cable compatible with the MHL standard are capable of controlling operation of each other. When the source apparatus is connected to the sink apparatus whose primary power supply is not turned off via a cable compatible with the MHL standard, the sink apparatus is activated, and video being reproduced by the source apparatus is (automatically) displayed on the sink apparatus.

It should be avoided, however, to immediately display, in the sink apparatus, video and information of the source apparatus connected to the sink apparatus for the charging purpose, for example.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary diagram showing an example of a system for transmitting and receiving according to an embodiment;

FIG. 2 is an exemplary diagram showing an example of a video receiving apparatus according to an embodiment;

FIG. 3 is an exemplary diagram showing an example of a mobile terminal according to an embodiment;

FIG. 4 is an exemplary diagram showing an example of a system for transmitting and receiving according to an embodiment;

FIG. 5 is an exemplary diagram showing an example of a system for transmitting and receiving according to an embodiment;

FIG. 6 is an exemplary diagram showing an example of a displaying for video receiving apparatus according to an embodiment;

FIG. 7 is an exemplary diagram showing an example of a displaying for video receiving apparatus according to an embodiment;

FIG. 8 is an exemplary diagram showing an example of a displaying for video receiving apparatus according to an embodiment;

FIG. 9 is an exemplary diagram showing an example of a displaying for video receiving apparatus according to an embodiment;

FIG. 10 is an exemplary diagram showing an example of a displaying for video receiving apparatus according to an embodiment;

FIG. 11 is an exemplary diagram showing an example of a displaying for video receiving apparatus according to an embodiment;

FIG. 12 is an exemplary diagram showing an example of a process for transmitting and receiving according to an embodiment;

FIG. 13 is an exemplary diagram showing an example of a process for transmitting and receiving according to an embodiment;

FIG. 14 is an exemplary diagram showing an example of a process for transmitting and receiving according to an embodiment;

FIG. 15 is an exemplary diagram showing an example of a process for transmitting and receiving according to an embodiment;

FIG. 16 is an exemplary diagram showing an example of a process for transmitting and receiving according to an embodiment;

FIG. 17 is an exemplary diagram showing an example of a process for transmitting and receiving according to an embodiment;

FIG. 18 is an exemplary diagram showing an example of a displaying for video receiving apparatus according to an embodiment;

FIG. 19 is an exemplary diagram showing an example of a displaying for video receiving apparatus according to an embodiment;

FIG. 20 is an exemplary diagram showing an example of a displaying for video receiving apparatus according to an embodiment;

FIG. 21 is an exemplary diagram showing an example of a displaying for video receiving apparatus according to an embodiment;

FIG. 22 is an exemplary diagram showing an example of a displaying for video receiving apparatus according to an embodiment;

FIG. 23 is an exemplary diagram showing an example of a displaying for video receiving apparatus according to an embodiment; and

FIG. 24 is an exemplary diagram showing an example of a process for transmitting and receiving according to an embodiment.

### DETAILED DESCRIPTION

Various embodiments will be described hereinafter with reference to the accompanying drawings.

In general, according to one embodiment, an electronic device comprising: a display configured to display video; a reception module configured to receive a video signal from a connected device; and a controller configured to perform a display process of displaying input video corresponding to the video signal received by the reception module in the video being displayed by the display.

Embodiments will now be described hereinafter in detail with reference to the accompanying drawings.

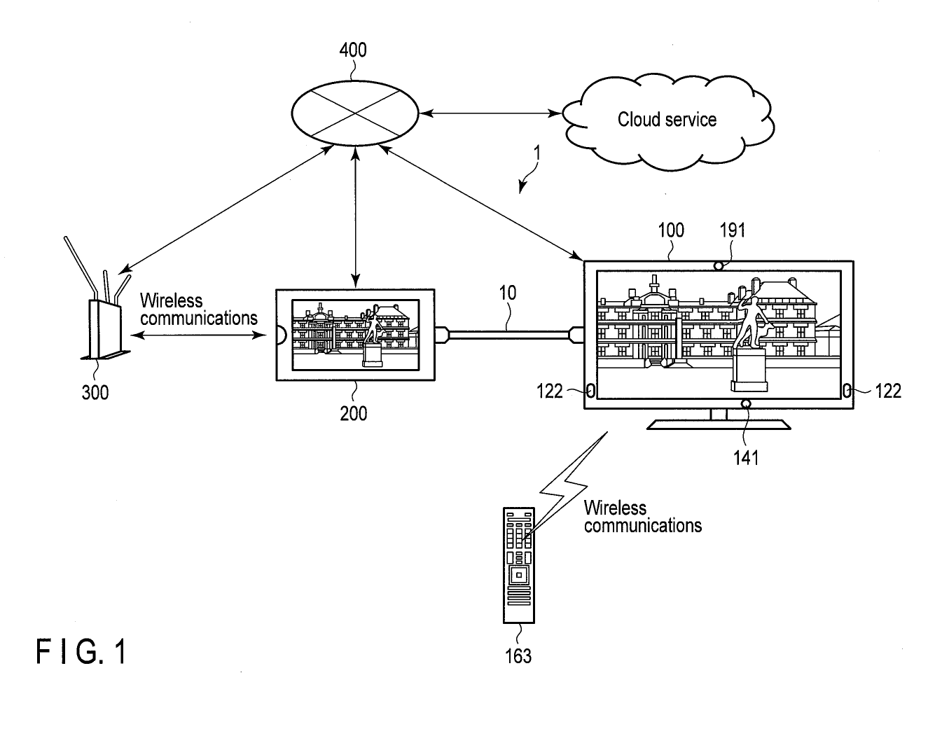

FIG. 1 shows an exemplary diagram of a transmitting and receiving system according to an embodiment. Elements and configurations which will be described below may be embodied either as software by a microcomputer (processor; CPU (central processing unit)) or as hardware. Contents to be displayed on a monitor can be arbitrarily acquired by using space waves (electronic waves), using a cable (including optical fiber) or a network such as an Internet Protocol (Internet Protocol) communication network, processing a streaming video signal from a network, or using a video transfer technique that uses a network function, for example. A content will also be referred to as a stream, a program, or information, and includes video, speech, music, and the like. Video includes moving images, still images, texts (information expressed by characters, symbols, and the like represented by a coded string), and an arbitrary combination thereof.

A transmitting and receiving system 1 is formed of a plurality of electronic devices, such as an image receiving device (sink apparatus) 100, a control device (source apparatus) 200, and a wireless communication terminal 300, for example.

The image receiving device (sink apparatus) 100 is a broadcast receiver capable of reproducing a broadcast signal, a video content stored in a storage medium, and the like, or a video processing apparatus such as a video player (recorder) capable of recording and reproducing a content, for example. If the image receiving device 100 can be functioned as a sink apparatus, the image receiving device 100 may be a recorder (video recording apparatus) capable of recording and reproducing contents on and from an optical disk compatible with the Blu-ray Disc (BD) standard, an optical disk compatible with the digital versatile disk (DVD) standard and a hard disk drive (HDD), for example. If the device 100 can be functioned as a sink apparatus, may be a set-top box (STB) which receives contents and supplies the contents to the video processing apparatus, for example.

The control device (source apparatus) 200 is a mobile terminal device (hereinafter referred to as a mobile terminal), such as a mobile telephone terminal, a tablet personal computer (PC), a portable audio player, a handheld video game console, and the like, which includes a display, an operation module, and a communication module, for example.

The wireless communication terminal 300 is capable of performing wired or wireless communications with each of the image receiving device 100 and the mobile terminal 200. That is, the wireless communication terminal 300 functions as an access point (AP) of wireless communications of the image receiving device 100 or the mobile terminal 200. Further, the wireless communication terminal 300 is capable of connecting to a cloud service (a variety of servers), for example, via a network 400. That is, the wireless communication terminal 300 is capable of accessing the network 400 in response to a connection request from the image receiving device 100 or the mobile terminal 200. Thereby, the image receiving device 100 and the mobile terminal 200 are capable of acquiring a variety of data from a variety of servers on the network 400 (or a cloud service) via the wireless communication terminal 300.

The image receiving device 100 is mutually connected to the mobile terminal 200 via a communication cable (hereinafter referred to as MHL cable) 10 compatible with the Mobile High-Definition Link (MHL) standard. The MHL cable 10 is a cable including a High-Definition Digital Multimedia Interface (HDMI) terminal having a shape compatible with the HDMI standard on one end, and a Universal Serial Bus (USB) terminal having a shape compatible with the USB standard, such as the micro-USB standard, on the other end.

The MHL standard is an interface standard which allows the user to transmit moving image data (streams) including video and moving images. According to the MHL standard, an electronic device (Source apparatus (mobile terminal 200)) on the side that outputs a stream outputs a stream to an electronic device (Sink apparatus (image receiving device 100) on the side that receives a stream, via an MHL cable. The sink apparatus 100 is capable of causing the display to display video obtained by reproducing the received stream. Further, the source apparatus 200 and the sink apparatus 100 are capable of operating and controlling each other, by transmitting a command to the counterpart apparatus connected via the MHL cable 10. That is, according to the MHL standard, control similar to the current HDMI-Consumer Electronics Control (CEC) standard can be performed.

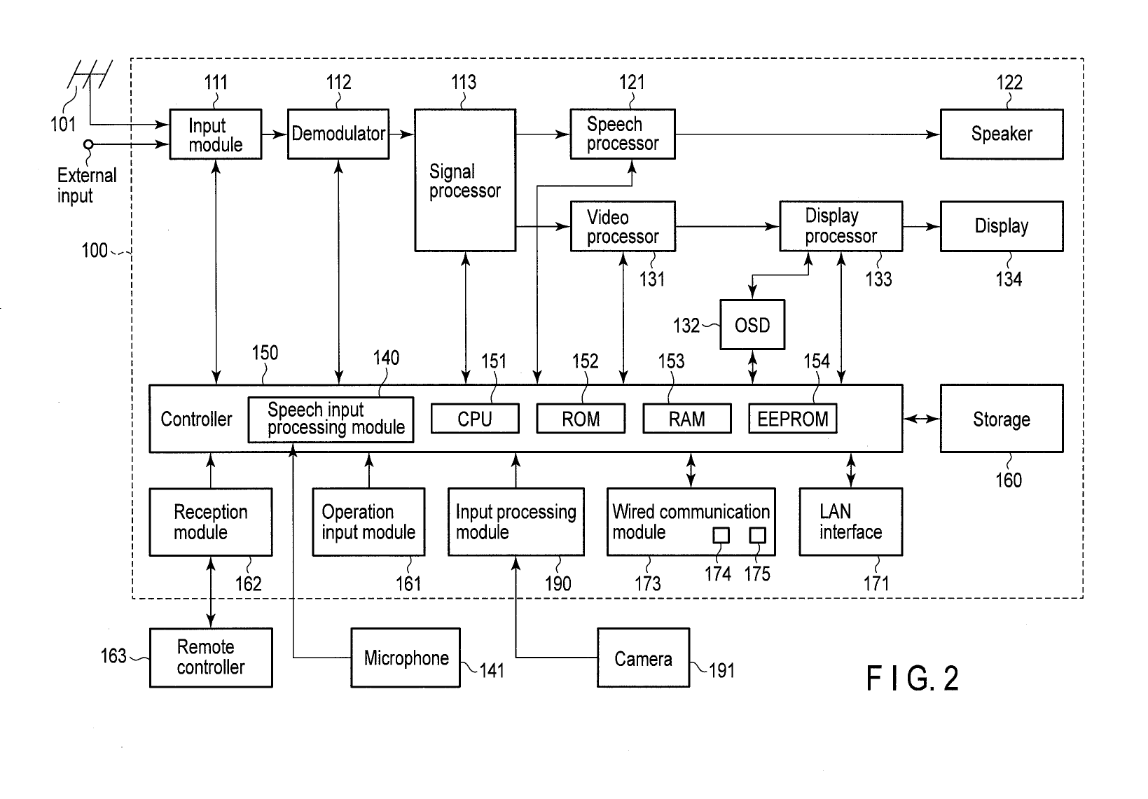

FIG. 2 shows an example of the video processing apparatus 100.

The video processing apparatus (image receiving device) 100 comprises an input module 111, a demodulator 112, a signal processor 113, a speech processor 121, a video processor 121, a video processor 131, an OSD processor 132, a display processor 133, a controller 150, a storage 160, an operation input module 161, a reception module 162, a LAN interface 171, and a wired communication module 173. The video processing apparatus 100 further comprises a speaker 122 and a display 134. The video processing apparatus 100 receives a control input (operation instruction) from a remote controller 163, and supplies the controller 150 with a control command corresponding to the operation instruction (control input).

The input module 111 is capable of receiving a digital broadcast signal which can be received via an antenna 101, for example, such as a digital terrestrial broadcast signal, a Broadcasting Satellite (BS) digital broadcast signal, and/or a communications satellite (CS) digital broadcast signal. The input module 111 is also capable of receiving a content (external input) supplied via an STB, for example, or as a direct input.

The input module 111 performs tuning (channel tuning) of the received digital broadcast signal. The input module 111 supplies the tuned digital broadcast signal to the demodulator 112. As a matter of course, the external input made via the STB, for example, is directly supplied to the demodulator 112.

The image receiving device 100 may comprise a plurality of input modules (tuners) 111. In that case, the image receiving device 100 is capable of receiving a plurality of digital broadcast signals/contents simultaneously.

The demodulator 112 demodulates the tuned digital broadcast signal/content. That is, the demodulator 112 acquires moving image data (hereinafter referred to as a stream) such as a TS (transport stream) from the digital broadcast signal/content. The demodulator 112 inputs the acquired stream to the signal processor 113. The video processing apparatus 100 may comprise a plurality of demodulators 112. The plurality of demodulators 112 are capable of demodulating each of a plurality of digital broadcast signals/contents.

As described above, the antenna 101, the input module 111, and the demodulator 112 function as reception means for receiving a stream.

The signal processor 113 performs signal processing such as a separation process on the stream. That is, the signal processor 113 separates a digital video signal, a digital speech signal, and other data signals, such as electronic program guides (EPGs) and text data formed of characters and codes called datacasting, from the stream. The signal processor 113 is capable of separating a plurality of streams demodulated by the plurality of demodulators 112.

The signal processor 113 supplies the speech processor 121 with the separated digital audio signal. The signal processor 113 supplies the video processor 131 with the separated digital video signal, also. Further, the signal processor 113 supplies a data signal such as EPG data to the controller 150.

Moreover, the signal processor 113 is capable of converting the stream into data (recording stream) in a recordable state on the basis of control by the controller 150. Further, the signal processor 113 is capable of supplying the storage 160 or other modules with a recording stream on the basis of control by the controller 150.

Still further, the signal processor 113 is capable of converting (transcoding) a bit rate of the stream from a bit rate set originally (in the broadcast signal/content) into a different bit rate. That is, the signal processor 113 is capable of transcoding (converting) the original bit rate of the acquired broadcast signal/content into a bit rate lower than the original bit rate. Thereby, the signal processor 113 is capable of recording a content (program) with less capacity.

The speech processor 121 converts a digital speech signal received by the signal processor 113 into a signal (audio signal) in a format that can be reproduced by the speaker 122. That is, the speech processor 121 includes a digital-to-analog (D/A) converter, and converts the digital speech signal into an analogue audio (acoustic)/speech signal. The speech processor 121 supplies the speaker 122 with the converted audio (acoustic)/speech signal. The speaker 122 reproduces the speech and the acoustic sound on the basis of the supplied audio (acoustic)/speech signal.

The video processor 131 converts the digital video signal from the signal processor 113 into a video signal in a format that can be reproduced by the display 134. That is, the video processor 131 decodes the digital video signal received from the signal processor 113 into a video signal in a format that can be reproduced by the display 134. The video processor 131 outputs the decoded video signal to the display processor 133.

The OSD processor 132 generates an On-Screen Display (OSD) signal for displaying a Graphical User Interface (GUI), subtitles, time, an application compatible/incompatible message, or notification information on incoming speech communication data or other incoming communication data similar thereto to the video and audio being reproduced, which is received by the mobile terminal 200, and the like, by superimposing such displays on a display signal from the video processor 131, on the basis of a data signal supplied from the signal processor 113, and/or a control signal (control command) supplied from the controller 150.

The display processor 133 adjusts color, brightness, sharpness, contrast, or other image qualities of the received video signal on the basis of control by the controller 150, for example. The display processor 133 supplies the display 134 with the video signal subjected to image quality adjusting. The display 134 displays video on the basis of the supplied video signal.

Further, the display processor 133 superimposes a display signal from the video processor 131 subjected to the image quality adjusting on the OSD signal from the OSD processor 132, and supplies the superimposed signal to the display 1341.

The display 134 includes a liquid crystal display panel including a plurality of pixels arranged in a matrix pattern and a liquid crystal display device including a backlight which illuminates the liquid crystal panel, for example. The display 134 displays video on the basis of the video signal supplied from the display processor 133.

The image receiving device 100 may be configured to include an output terminal which outputs a video signal, in place of the display 134. Further, the image receiving device 100 may be configured to include an output terminal which outputs an audio signal, in place of the speaker 122. Moreover, the video processing apparatus 100 may be configured to include an output terminal which outputs a digital video signal and a digital speech signal.

The controller 150 functions as control means for controlling an operation of each element of the image receiving device 100. The controller 150 includes a CPU 151, a ROM 152, a RAM 153, an EEPROM (non-volatile memory) 154, and the like. The controller 150 performs a variety of processes on the basis of an operation signal supplied from the operation input module 161.

The CPU 151 includes a computing element, for example, which performs a variety of computing operations. The CPU 151 embodies a variety of functions by performing programs stored in the ROM 152, the EEPROM 154, or the like.

The ROM 152 stores programs for controlling the image receiving device 100, programs for embodying a variety of functions, and the like. The CPU 151 activates the programs stored in the ROM 152 on the basis of the operation signal supplied from the operation input module 161. Thereby, the controller 150 controls an operation of each element.

The RAM 153 functions as a work memory of the CPU 151. That is, the RAM 153 stores a result of computation by the CPU 151, data read by the CPU 151, and the like.

The EEPROM 154 is a non-volatile memory which stores a variety of setting information, programs, and the like.

The storage 160 includes a storage medium which stores contents. The storage 160 is, for example, a hard disk drive (HDD), a solid-state drive (SSD), a semiconductor memory, or the like. The storage 160 is capable of storing a recorded stream, text data, and the like supplied from the signal processor 113.

The operation input module 161 includes an operation key, a touchpad, or the like, which generates an operation signal in response to an operation input from the user, for example. The operation input module 161 may be configured to receive an operation signal from a keyboard, a mouse, or other input devices capable of generating an operation signal. The operation input module 161 supplies the controller 150 with the operation signal.

A touchpad includes a device capable of generating positional information on the basis of a capacitance sensor, a thermosensor, or other systems. When the image receiving device 100 comprises the display 134, the operation input module 161 may be configured to include a touch panel formed integrally with the display 134.

The reception module 162 includes a sensor, for example, which receives an operation signal from the remote controller 163 supplied by an infrared (IR) system, for example. The reception module 162 supplies the controller 150 with the received signal. The controller 150 receives the signal supplied from the reception module 162, amplifies the received signal, and decodes the original operation signal transmitted from the remote controller 163 by performing an analog-to-digital (A/D) conversion of the amplified signal.

The remote controller 163 generates an operation signal on the basis of an operation input from the user. The remote controller 163 transmits the generated operation signal to the reception module 162 via infrared communications. The reception module 162 and the remote controller 163 may be configured to transmit and receive an operation signal via other wireless communications using radio waves (RF), for example.

The local area network (LAN) interface 171 is capable of performing communications with other devices on the network 400 via the wireless communication terminal 300 by a LAN or a wireless LAN. Thereby, the video processing apparatus 100 is capable of performing communications with other devices connected to the wireless communication terminal 300. For example, the image receiving device 100 is capable of acquiring a stream recorded in a device on the network 400 via the LAN interface 171, and reproducing the acquired stream.

The wired communication module 173 is an interface which performs communications on the basis of standards such as HDMI and MHL. The wired communication module 173 includes an HDMI terminal, not shown, to which an HDMI cable or an MHL cable can be connected, an HDMI processor 174 configured to perform signal processing on the basis of the HDMI standard, and an MHL processor 175 configured to perform signal processing on the basis of the MHL standard.

A terminal of the MHL cable 10 on the side that is connected to the image receiving device 100 has a structure compatible with the HDMI cable. The MHL cable 10 includes a resistance between terminals (detection terminals) that are not used for communications. The wired communication module 173 is capable of determining whether the MHL cable or the HDMI cable is connected to the HDMI terminal by applying a voltage to the detection terminals.

The image receiving device 100 is capable of receiving a stream output from a device (Source apparatus) connected to the HDMI terminal of the wired communication module 173 and reproducing the received stream. Further, the image receiving device 100 is capable of outputting a stream to the device (Sink apparatus) connected to the HDMI terminal of the wired communication module 173.

The controller 150 supplies a stream received by the wired communication module 173 to the signal processor 113. The signal processor 113 separates a digital video signal, a digital speech signal, and the like from the received (supplied) stream. The signal processor 113 transmits the separated digital video signal to the video processor 131, and the separated digital speech signal to the speech processor 121. Thereby, the image receiving device 100 is capable of reproducing the stream received by the wired communication module 173.

The image receiving device 100 further comprises a power-supply section, not shown. The power-supply section receives power from a commercial power source, for example, via an AC adaptor, for example. The power-supply section converts the received alternating-current power into direct-current power, and supplies the converted power to each element of the image receiving device 100.

The image receiving device 100 includes an input processing module 190, and a camera 191 connected to the input processing module 190. An image (of the user) acquired by the camera 191 is input to the control module 150 via the input processing module 190, and is subjected to predetermined processing and digital signal processing by the signal processor 113 connected to the control module 150.

Further, the image receiving device 100 includes a speech input processor 140 connected to the control module 150, and is capable of processing start and end of a call on the basis of speech information acquired by the microphone 141.

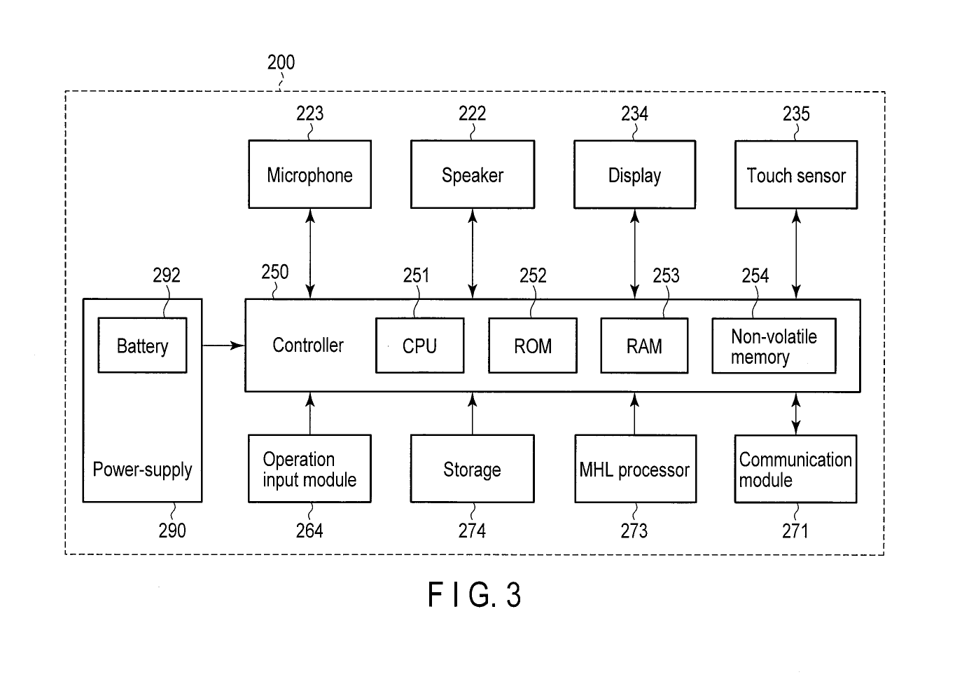

FIG. 3 shows an exemplary diagram of the mobile terminal 200.

The mobile terminal (cooperating device) 200 comprises a controller 250, an operation input module 264, a communication module 271, an MHL processor 273, and a storage 274. Further, the mobile terminal 200 comprises a speaker 222, a microphone 223, a display 234, and a touch sensor 235.

The control module 250 functions as a controller configured to control an operation of each element of the mobile terminal 200. The control module 250 includes a CPU 251, a ROM 252, a RAM 253, a non-volatile memory 254, and the like. The control module 250 performs a variety of operations on the basis of an operation signal supplied from the operation input module 264 or the touch sensor 235. The control module 250 also performs control of each element corresponding to a control command supplied from the image receiving device 100 via the MHL cable 10, activation of an application, and a process (execution of the function) supplied by the application (which may be performed by the CPU 251).

The CPU 251 includes a computing element configured to execute a variety of computing operations. The CPU 251 embodies a variety of functions by executing programs stored in the ROM 252 or the non-volatile memory 254, for example.

Further, the CPU 251 is capable of performing a variety of processes on the basis of data such as applications stored in the storage device 274. The CPU 251 also performs control of each element corresponding to a control command supplied from the image receiving device 100 via the MHL cable 10, activation of an application, and a process supplied by the application (execution of the function).

The ROM 252 stores programs for controlling the mobile terminal 200, programs for embodying a variety of functions, and the like. The CPU 251 activates the programs stored in the ROM 252 on the basis of an operation signal from the operation input module 264. Thereby, the controller 250 controls an operation of each element.

The RAM 253 functions as a work memory of the CPU 251. That is, the RAM 253 stores a result of computation by the CPU 251, data read by the CPU 251, and the like.

The non-volatile memory 254 is a non-volatile memory configured to store a variety of setting information, programs, and the like.

The controller 250 is capable of generating a video signal to be displayed on a variety of screens, for example, according to an application being executed by the CPU 251, and causes the display 234 to display the generated video signal. The display 234 reproduces moving images (graphics), still images, or character information on the basis of the supplied moving image signal (video). Further, the controller 250 is capable of generating an audio signal to be reproduced, such as various kinds of speech, according to the application being executed by the CPU 251, and causes the speaker 222 to output the generated speech signal. The speaker 222 reproduces sound (acoustic sound/speech) on the basis of a supplied audio signal (audio).

The microphone 223 collects sound in the periphery of the mobile terminal 200, and generates an acoustic signal. The acoustic signal is converted into acoustic data by the control module 250 after A/D conversion, and is temporarily stored in the RAM 253. The acoustic data is converted (reproduced) into speech/acoustic sound by the speaker 222, after D/A conversion, as necessary. The acoustic data is used as a control command in a speech recognition process after A/D conversion.

The display 234 includes, for example, a liquid crystal display panel including a plurality of pixels arranged in a matrix pattern and a liquid crystal display device including a backlight which illuminates the liquid crystal panel. The display 234 displays video on the basis of a video signal.

The touch sensor 235 is a device configured to generate positional information on the basis of a capacitance sensor, a thermo-sensor, or other systems. The touch sensor 235 is provided integrally with the display 234, for example. Thereby, the touch sensor 235 is capable of generating an operation signal on the basis of an operation on a screen displayed on the display 234 and supplying the generated operation signal to the controller 250.

The operation input module 264 includes a key which generates an operation signal in response to an operation input from the user, for example. The operation input module 264 includes a volume adjustment key for adjusting the volume, a brightness adjustment key for adjusting the display brightness of the display 234, a power key for switching (turning on/off) the power states of the mobile terminal 200, and the like. The operation input module 264 may further comprise a trackball, for example, which causes the mobile terminal 200 to perform a variety of selection operations. The operation input module 264 generates an operation signal according to an operation of the key, and supplies the controller 250 with the operation signal.

The operation input module 264 may be configured to receive an operation signal from a keyboard, a mouse, or other input devices capable of generating an operation signal. For example, when the mobile terminal 200 includes a USB terminal or a module which embodies a Bluetooth (registered trademark) process, the operation input module 264 receives an operation signal from an input device connected via USB or Bluetooth, and supplies the received operation signal to the controller 250.

The communication module 271 is capable of performing communications with other devices on the network 400 via the wireless communication terminal 300, using a LAN or a wireless LAN. Further, the communication module 271 is capable of performing communications with other devices on the network 400 via a portable telephone network. Thereby, the mobile terminal 200 is capable of performing communications with other devices connected to the wireless communication terminal 300. For example, the mobile terminal 200 is capable of acquiring moving images, pictures, music data, and web content recorded in devices on the network 400 via the communication module 271 and reproducing the acquired content.

The MHL processor 273 is an interface which performs communications on the basis of the MHL standard. The MHL processor 273 performs signal processing on the basis of the MHL standard. The MHL processor 273 includes a USB terminal, not shown, to which an MHL cable can be connected.

The mobile terminal 200 is capable of receiving a stream output from a device (source apparatus) connected to the USB terminal of the MHL processor 273, and reproducing the received stream. Further, the mobile terminal 200 is capable of outputting a stream to a device (sink apparatus) connected to the USB terminal of the MHL processor 273.

Moreover, the MHL processor 273 is capable of generating a stream by superimposing a video signal to be displayed on a speech signal to be reproduced. That is, the MHL processor 273 is capable of generating a stream including video to be displayed on the display 234 and audio to be output from the speaker 222.

For example, the controller 250 supplies the MHL processor 273 with a video signal to be displayed and an audio signal to be reproduced, when an MHL cable is connected to the USB terminal of the MHL processor 273 and the mobile terminal 200 operates as a source apparatus. The MHL processor 273 is capable of generating a stream in a variety of formats (for example, 1080i and 60 Hz) using the video signal to be displayed and the audio signal to be reproduced. That is, the mobile terminal 200 is capable of converting a display screen to be displayed on the display 234 and audio to be reproduced by the speaker 222 into a stream. The controller 250 is capable of outputting the generated stream to the sink apparatus connected to the USB terminal.

The mobile terminal 200 further comprises a power-supply 290. The power-supply 290 includes a battery 292, and a terminal (such as a DC jack) for connecting to an adaptor which receives power from a commercial power source, for example. The power-supply 290 charges the battery 292 with the power received from the commercial power source. Further, the power-supply 290 supplies each element of the mobile terminal 200 with the power stored in the battery 292.

The storage 274 includes a hard disk drive (HDD), a solid-state drive (SSD), a semiconductor memory, and the like. The storage 274 is capable of storing content such as programs, applications, moving images that are executed by the CPU 251 of the controller 250, a variety of data, and the like.

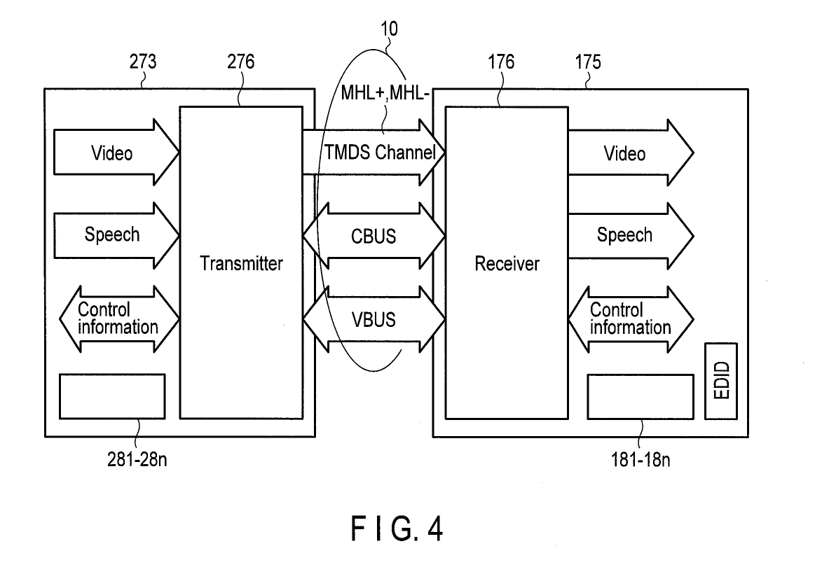

FIG. 4 is an exemplary diagram illustrating mutual communications between the electronic devices based on the MHL standard. In FIG. 4, the mobile terminal 200 is a source apparatus, and the image receiving device 100 is a sink apparatus, by way of example.

The MHL processor 273 of the mobile terminal 200 includes a transmitter 276 and a receiver, not shown. The MHL processor 175 of the image receiving device 100 includes a transmitter (not shown) and a receiver 176.

The transmitter 276 and the receiver 176 are connected via the MHL cable 10.

When a Micro-USB terminal is applied as a connector at the time of implementation, the MHL cable is formed of the following 5 lines: a VBUS (power) line; an MHL−(differential pair [−(minus)] line; an MHL+(differential pair [+(plus)] line; a CBUS (control signal) line, and a GND (ground) line.

The VBUS line supplies power from the sink apparatus to the source apparatus (functions as a power line). That is, in the connection of FIG. 4, the sink apparatus (power supplying source (image receiving device 100)) supplies the source apparatus (mobile terminal 200) with power of +5V via the VBUS line. Thereby, the sink apparatus is capable of operating using the power supplied from the sink apparatus (via the VBUS line). The mobile terminal 200 as the source apparatus operates using power supplied from the battery 292, during independent operation. When the mobile terminal 200 is connected to the sink apparatus via the MHL cable 10, on the other hand, the battery 292 can be charged with the power supplied via the VBUS line from the sink apparatus.

The CBUS line is used for bi-directionally transmitting a Display Data Channel (DDC) command, an MHL sideband channel (MSC) command, or an arbitrary control command(s) corresponding to application(s), for example.

A DDC command is used for reading of data (information) stored in extended display identification data (EDID), which is information set in advance for notifying the counterpart apparatus of a specification (display ability) in a display, and recognition of High-bandwidth Digital Content Protection (HDCP), which is a system for encrypting a signal transmitted between the apparatuses, for example.

An MSC command is used for, for example, reading/writing a variety of resistors, transmitting MHL-compatible information and the like in an application stored in the counterpart device (cooperating device), notifying the image receiving device 100 of an incoming call when the mobile terminal receives the incoming call, and the like. That is, the MSC command can by the image receiving device 100 to read MHL-compatible information of the application stored in the mobile terminal 200, activate the application, make an incoming call notification (notification of an incoming call), and the like.

As described above, the image receiving device 100 as a sink apparatus outputs a predetermined control command, MHL-compatible information, and the like to the mobile terminal 200 as a source apparatus via the CBUS line. Thereby, the mobile terminal 200 is capable of performing a variety of operations in accordance with a received command (when compatible with MHL).

That is, the mobile terminal 200 (source apparatus) transmits a DDC command to the image receiving device 100 (sink apparatus), thereby performing HDCP recognition between the source apparatus and the sink apparatus and reading EDID from the sink apparatus. Further, the image receiving device 100 and the mobile terminal 200 transmit and receive a key, for example, in a procedure compliant with HDCP, and perform mutual recognition.

When the source apparatus (mobile terminal 200) and the sink apparatus (image receiving device 100) are recognized by each other, the source apparatus and the sink apparatus are capable of transmitting and receiving encrypted signals to and from each other. The mobile terminal 200 reads the EDID from the image receiving device 100 in the midst of HDCP recognition with the image receiving device 100. Reading (acquisition) of the EDID may be performed at independent timing different from that of HDCP recognition.

The mobile terminal 200 analyzes the EDID acquired from the image receiving device 100, and recognizes display information indicating a format including a resolution, a color depth, a transmission frequency, and the like that can be processed by the image receiving device 100. The mobile terminal 200 generates a stream in a format including a resolution, a color depth, a transmission frequency, and the like that can be processed by the image receiving device 100.

The MHL+ and the MHL− are lines for transmitting data. The two lines of MHL+ and the MHL− function as a twist pair. For example, the MHL+ and the MHL− function as a transition minimized differential signaling (TMDS) channel which transmits data in the TMDS system. Further, the MHL+ and the MHL− are capable of transmitting a synchronization signal (MHL clock) in the TMDS system.

For example, the mobile terminal 200 is capable of outputting a stream to the image receiving device 100 via the TMDS channel. That is, the mobile terminal 200 which functions as the source apparatus is capable of transmitting a stream obtained by converting video (display screen) to be displayed on the display 234 and the audio to be output from the speaker 222 to the image receiving device 100 as the sink apparatus. The image receiving device 100 receives the stream transmitted using the TMDS channel, performs signal processing of the received stream, and reproduces the stream.

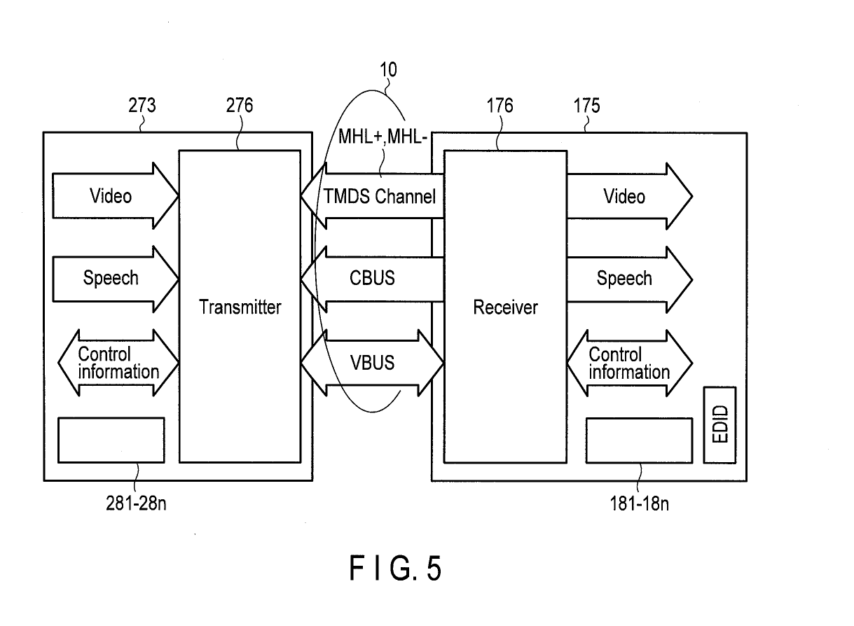

FIG. 5 is an exemplary diagram of the embodiment applied to mutual communications between the electronic apparatuses shown in FIG. 4.

In the embodiment shown in FIG. 5, an MSC command is supplied from the image receiving device 100 to the mobile terminal 200 via the CBUS line. Further, names of applications stored in the mobile terminal 200 (and MHL-compatible information of each application) can be read (acquired) from the image receiving device 100. It is to be noted that the HDCP recognition and EDID acquisition described with reference to FIG. 4 have been completed before the control command (MSC command) is supplied (transmitted) and the MHL− compatible information is read (acquired).

The owner of the portable terminal (source apparatus) 200 is capable of connecting the mobile terminal 200 (electrically) to the sink apparatus 100 connected via the MHL cable 10 merely for the purpose of charging the battery of the mobile terminal 200.

In terms of specifications at the time of MHL connection, control can be performed in a manner similar to that of the HDMI-Consumer Electronics Control (CEC) standard. Accordingly, when the mobile terminal 200 is connected to the image receiving device 100 merely for the purpose of charging the battery, an application being activated or video being reproduced in the mobile terminal 200 is displayed on the screen of the image receiving device 100, regardless of the intention of the owner (user).

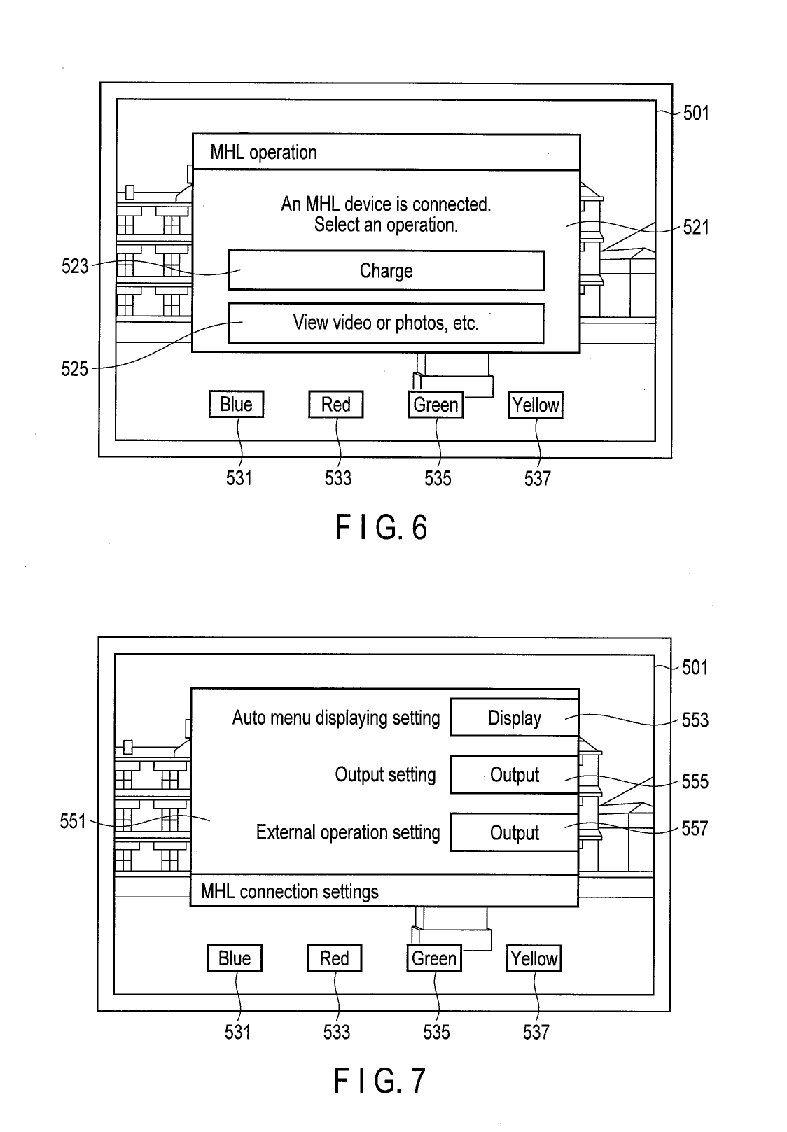

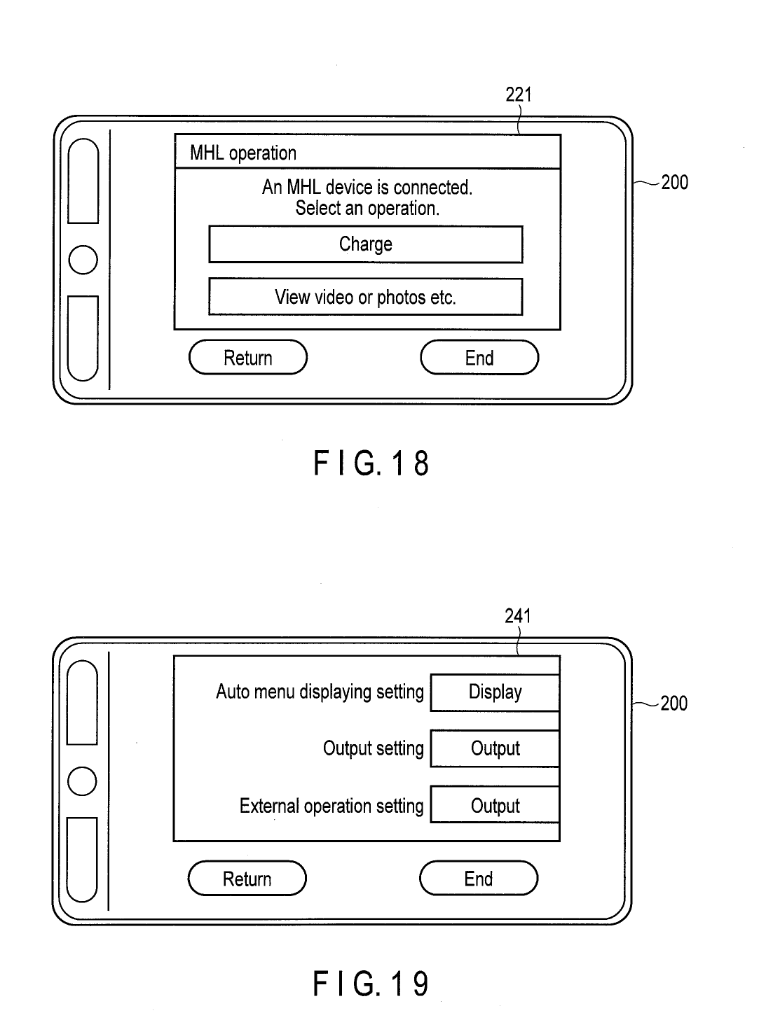

Under such backgrounds, the present embodiment is configured such that settings as to whether to display, in the image receiving device 100, an application being activated or video being reproduced in the mobile terminal 200, when the mobile terminal 200 is connected to the image receiving device 100 via an MHL cable, can be made from a setting screen (screen display) which will be described with reference to FIGS. 6-11 (and FIGS. 18-23).

FIG. 6 illustrates an example in which video or the like being displayed in the mobile terminal 200 is suppressed from being displayed on the screen of the image receiving device 100 regardless of the intention of the owner (user), when the mobile terminal 200 is connected to the image receiving device 100 via the MHL cable 10. In this example, an MHL operation setting screen 521 is displayed in an image display 501 being displayed on the image receiving device 100. That is, the screen 501 shown in FIG. 6 displays an MHL operation setting (auto-menu) screen 521 including a “Charge” button (bar) 523 via which a selection input (operation instruction via the remote controller 163) can be made for the purpose of charging the connected mobile terminal 200, and a “View video or photos” button (bar) 525 via which a selection input (operation instruction) can be made for the purpose of displaying video or the like being displayed in the mobile terminal 200.

That is, when the image receiving device 100 has detected that the mobile terminal 200 is connected via MHL, the image receiving device 100 displays the “Charge” button 523 and the “View video or photos” button 525 as the operation setting (auto-menu) screen 521 on the screen 501 being displayed at that point in time, and maintains (displays) a focus movement (remote control operation) by the remote controller 163 and a standby state waiting for input of an operation instruction by “Enter” button (input of a control command corresponding to “Enter”), for example, for a predetermined period of time.

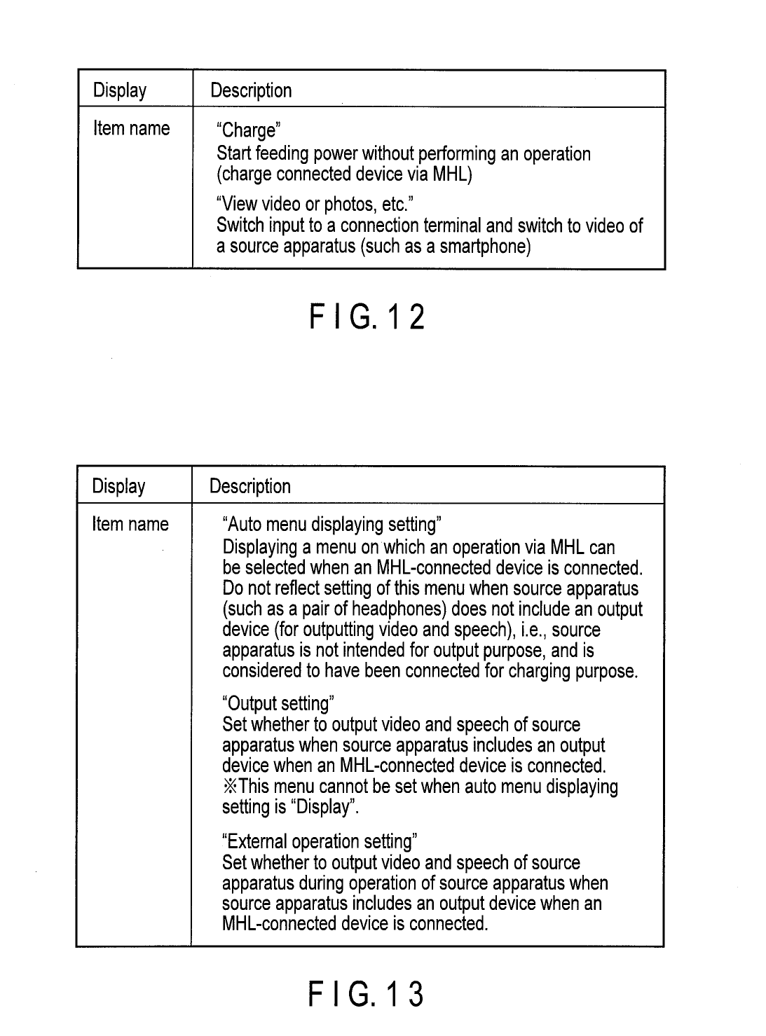

When a selection input is made with the “Charge” button (item name) 523 in the operation setting (auto-menu) screen 521 or the “View video or photos” button (item name) 525, an operation corresponding to each item, which will be described with reference to FIG. 12, is performed.

An operation instruction by “Enter” button (input of a control command corresponding to “Enter” button) or the like may be assigned to one of a “Blue” button 531, a “Red” button 533, a “Green” button 535, and a “Yellow” button 537, which are provided at predetermined positions in the screen display 501, correspond to a “Blue” key, a “Red” key, a “Green” key, and a “Yellow” key provided on the remote controller 163, respectively, and are configured to prompt the user to perform a key operation for a control input corresponding to a predetermined command set in the key of each color in each screen display. For example, when an output of a control command corresponding to “Enter” command is assigned to the “Yellow” button 537, the “Enter” command can be output by operating the “Yellow” key on the remote controller 163.

A screen similar to that of the operation setting (auto-menu) screen 521 is also displayed in a display of the mobile terminal 200, as exemplified in FIG. 18. Therefore, the owner (user) of the mobile terminal 200 is capable of making a selection input directly from the “Charge” button 223 or the “View video or photos” button 225 displayed on the display of the mobile terminal 200.

When the device 200 connected to the image receiving device 100 is embodied as a pair of headphones, or the like, which does not include an output module (for outputting video and speech) for use as the source apparatus and is not intended for outputting video or speech, display of the operation setting (auto-menu) screen (521) shown in FIG. 6 and an operation setting screen (221) shown in FIG. 18 can be omitted. That is, at the point in time when it is detected that the device 200 connected to the image receiving device 100 is a device not intended for output purpose, a charging operation may be started. It is possible to easily detect that the device 200 is not intended for output purpose on the basis of information unique to the device, such as a media access control (MAC) address.

Whether to display the operation setting (auto-menu) screen shown in FIG. 6 or not, i.e., whether to activate an auto-menu in the MHL-connected device or not can be set on an MHL connection setting screen shown in FIGS. 7 and 19. When an arbitrary selection input is made from each of a plurality of buttons that will be described below, an operation corresponding to each item that will be described with reference to FIG. 13 is executed.

An MHL connection setting screen 551 shown in FIG. 7 includes an auto-menu display setting button 553, an output setting button 555, and an external operation setting button 557, for example. The functions of the buttons, which are shown as a list in FIG. 13, will be described below. A screen similar to the MHL connection setting screen 551 is also displayed in the display of the mobile terminal 200, as exemplified in FIG. 19. Therefore, the owner (user) of the mobile terminal 200 is capable of directly making a selection input from each button displayed on the display of the mobile terminal 200.

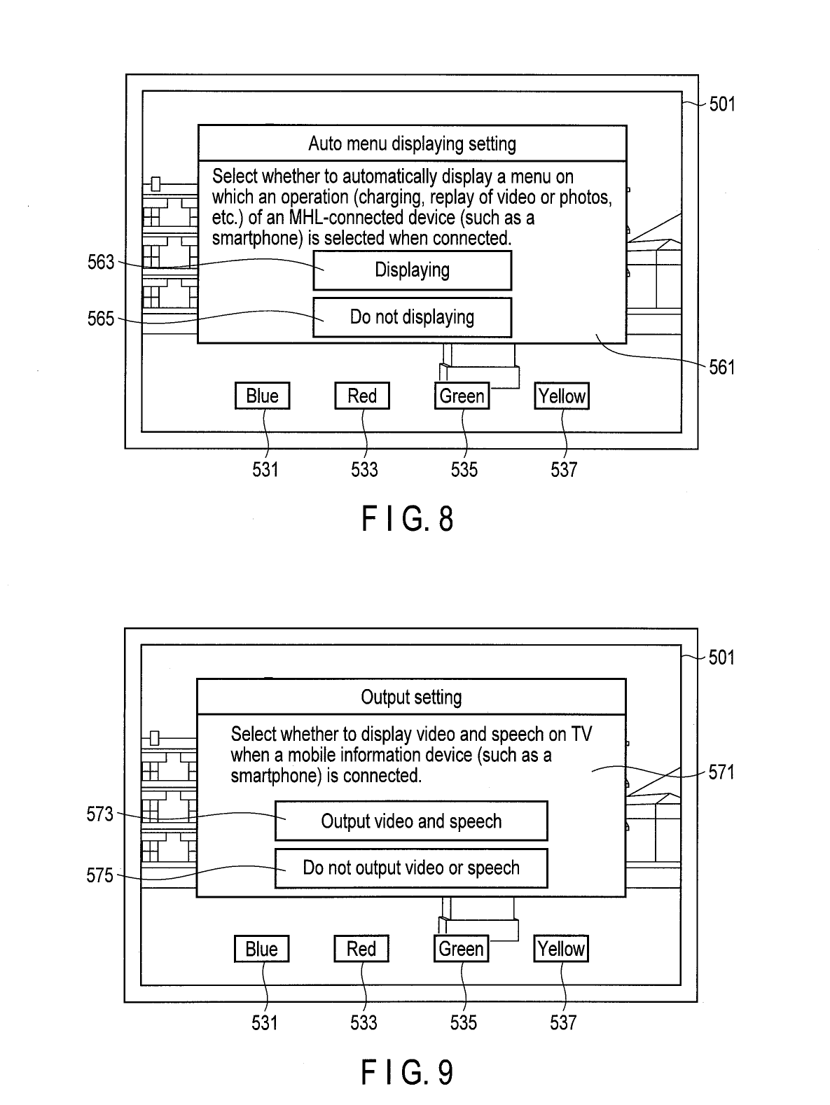

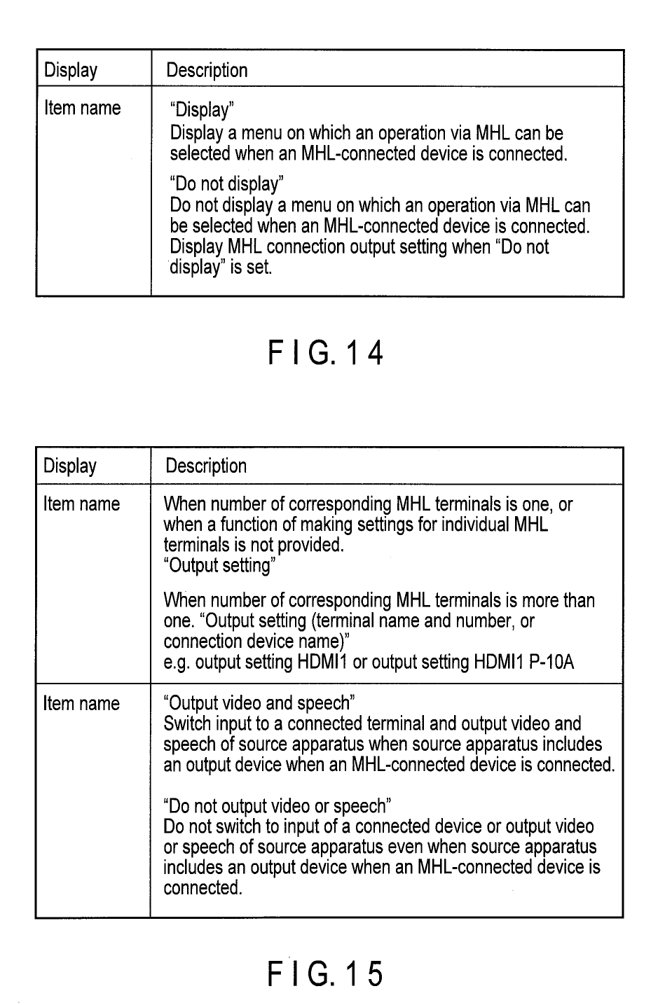

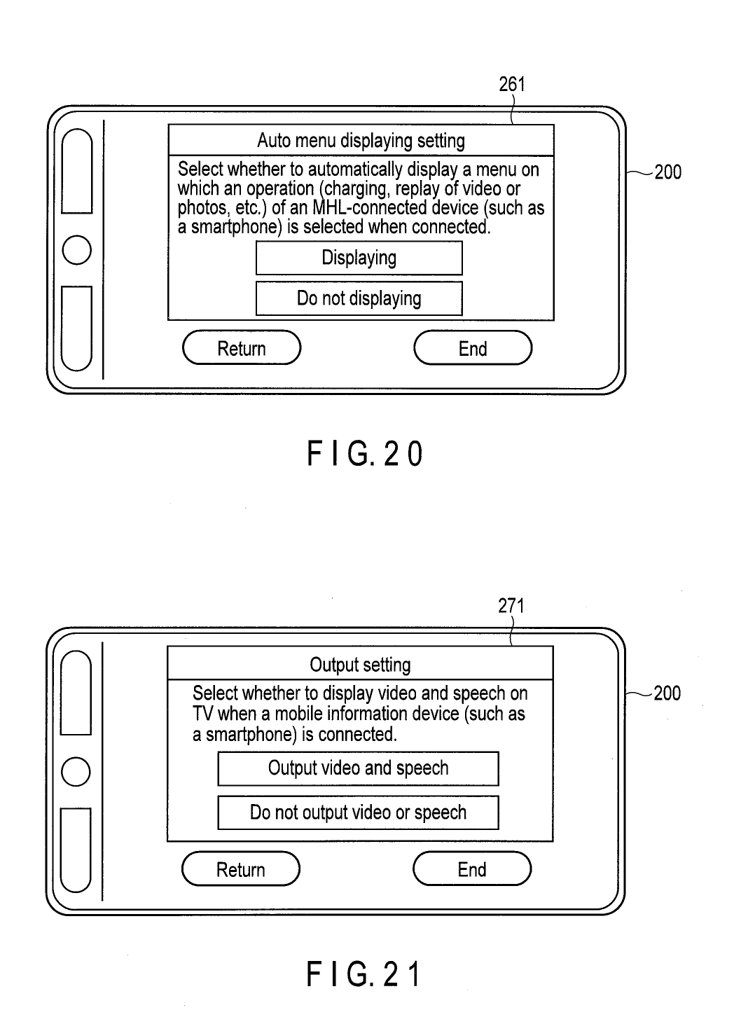

The auto-menu display setting button 553 is used for setting whether to display the [MHL operation setting (auto-menu)] screen shown in FIG. 6, and when a “Display” button 553 is selected, an [auto-menu display setting] screen 561, which will be described below with reference to FIG. 8, is displayed. That is, when the “Display” button 563 is selected in FIG. 8, activation of the auto-menu described with reference to FIG. 6 is set, and the MHL operation screen 521 shown in FIG. 6 is displayed whenever the device (mobile device) 200 is connected to the image receiving device 100 via MHL. Therefore, when a “Do not display” button 565 is selected, even when the device (mobile device) 200 is connected to the image receiving device 100 via MHL, the MHL operation screen 521 (shown in FIG. 6) is not displayed. A screen similar to the auto-menu display setting screen 561 is also displayed in the display of the mobile terminal 200, as exemplified in FIG. 20. Therefore, the owner (user) of the mobile terminal 200 is capable of making a selection input directly from each button displayed on the display of the mobile terminal 200. When an arbitrary selection input is made from each of a plurality of buttons that will be described below, an operation corresponding to each of a plurality of items that will be described with reference to FIG. 14 is performed.

An output setting button 555 displays an output setting screen 571, which will be described below with reference to FIG. 9. That is, when an “Output video and speech” button 573 is selected in FIG. 9, the “View video or photos” button 525 defined by the auto-menu of the MHL operation screen 521 described with reference to FIG. 6 is displayed via MHL whenever the device (mobile device) 200 is connected to the image receiving device 100. A screen similar to the output setting screen 571 is displayed in the display of the mobile terminal 200, as exemplified in FIG. 21. Therefore, the owner (user) of the mobile terminal 200 is capable of making a selection input directly from each button displayed on the display of the mobile terminal 200. When an arbitrary selection input is made from each of a plurality of buttons that will be described below, an operation corresponding to each of a plurality of items that will be described with reference to FIG. 15 is performed. In that case, it is possible to set whether to display the above-described auto-menu (whether to activate the auto-menu) or not, on the basis of the name and the number of the device or the name of the connection device connected to an arbitrary MHL device.

When a “Do not output video or speech” button 575 is selected, even when the device (mobile device) 200 is connected to the image receiving device 100 via MHL, the MHL operation screen 521 (shown in FIG. 6) is not displayed. In the example of FIG. 9, the “Output video and speech” button 573 and the “Do not output video or speech” button 575 are displayed (as OSD) as examples of output setting buttons 555. Output settings, however, can be configured such that an “Output video but do not output speech” button or a “Do not output video but output speech” button are displayed and a corresponding control input is received (processing is performed in accordance with a control input). It is also possible to display checkboxes, radio buttons, or the like, which allow the user to set whether to output or not each of video and speech individually, receive a corresponding control input, and perform processing in accordance with the control input.

An external operation setting button 557 displays an external operation setting screen 591, which will be described below with reference to FIG. 11. That is, when an “Output video and speech” button 593 is selected in FIG. 11, video or speech being reproduced by the mobile terminal 200 or an incoming call indication indicating receipt of an incoming call (such as an image by which the caller can be specified) is displayed whenever the device (mobile device) 200 connected to the image receiving device 100 via MHL is activated by a certain factor, for example, by being operated (by the user) or receiving an incoming call. A screen similar to the external operation setting screen 591 is also displayed in the display of the mobile terminal 200, as exemplified in FIG. 23. Therefore, the owner (user) of the mobile terminal 200 is capable of making a selection input directly from each button displayed on the display of the mobile terminal 200. When an arbitrary selection input is made from each of a plurality of buttons that will be described below, an operation corresponding to each of a plurality of items that will be described with reference to FIG. 17 is performed. When a “Do not output video or speech” button 595 is selected, video or speech being reproduced by the device (mobile device) 200 or an incoming call indication is not displayed when the device (mobile device) 200 connected to the image receiving device 100 is operated (by the user), receives an incoming call, or the like.

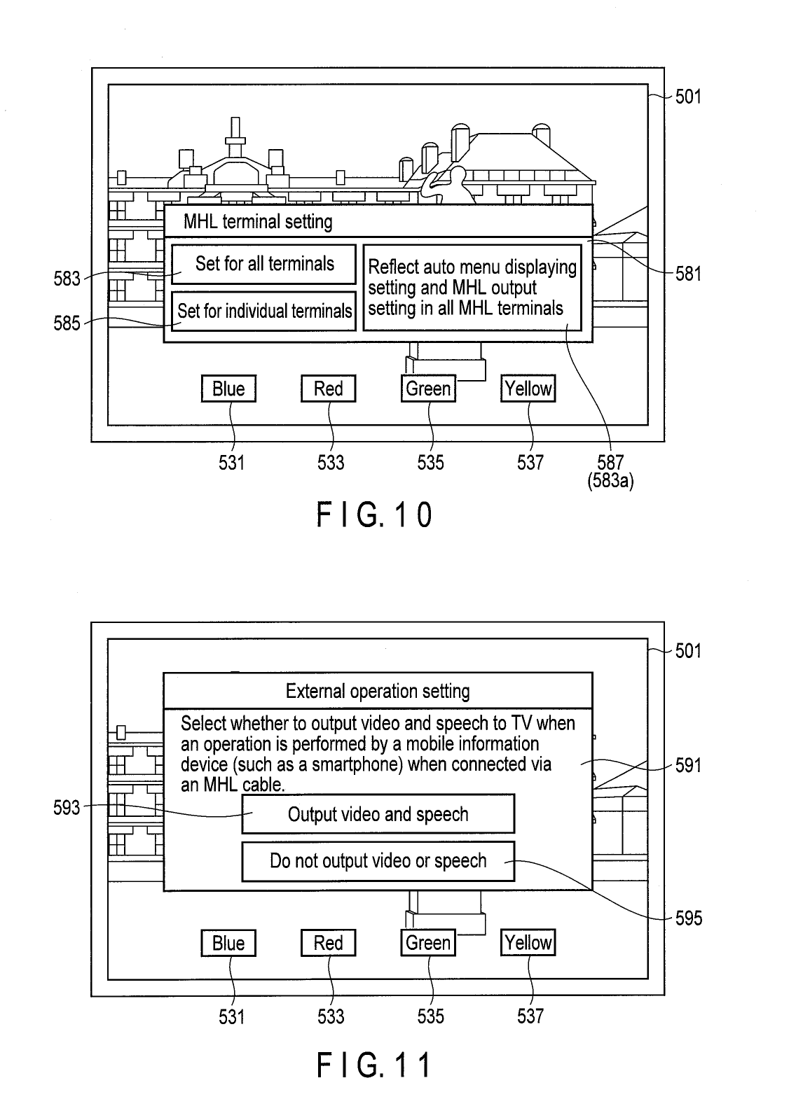

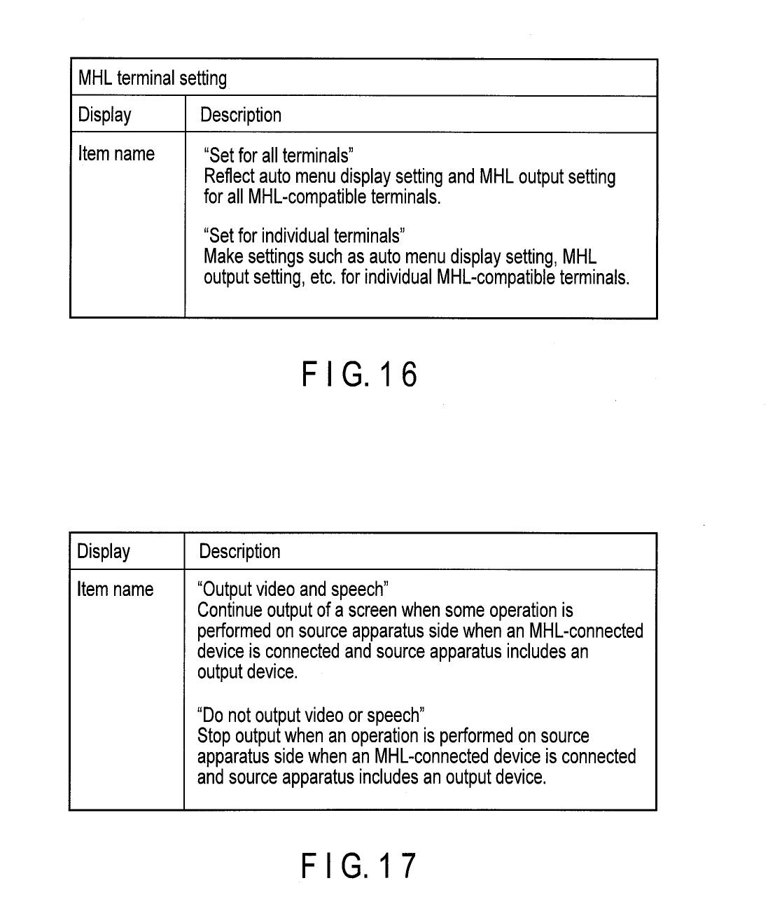

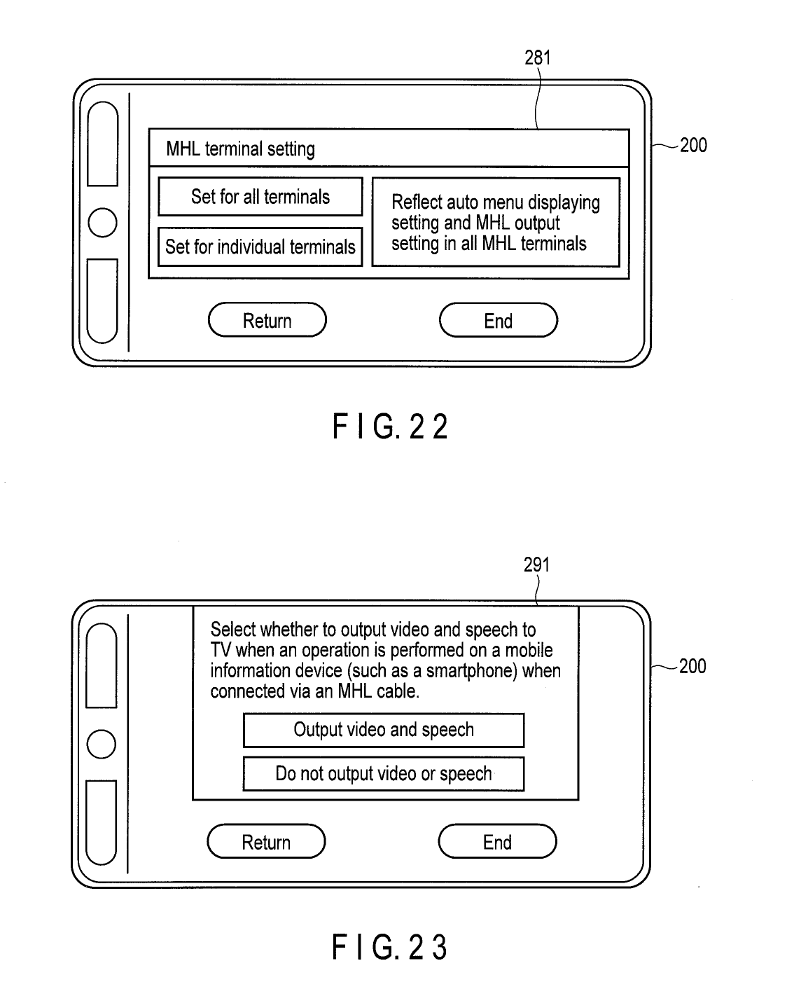

FIG. 10 relates to settings of each device when two or more MHL devices are provided in the image receiving device 100. For example, when two MHL devices are provided, the “Description” shown in FIG. 16 is displayed at predetermined timing, according to the number of devices, for which a plurality of MHL− compatible devices are provided in the image receiving device 100. Further, a screen similar to the MHL device setting screen 581 is also displayed in the display of the mobile terminal 200, as exemplified in FIG. 22. Therefore, the owner (user) of the mobile terminal 200 is capable of making a selection input directly from each button displayed on the display of the mobile terminal 200. When the “Do not output video or speech” button 595 is selected, the video or speech being reproduced by the device (mobile device) 200 connected to the image receiving device 100 or an incoming call indication is not displayed when the device (mobile device) 200 is operated (by the user), receives an incoming call, or the like.

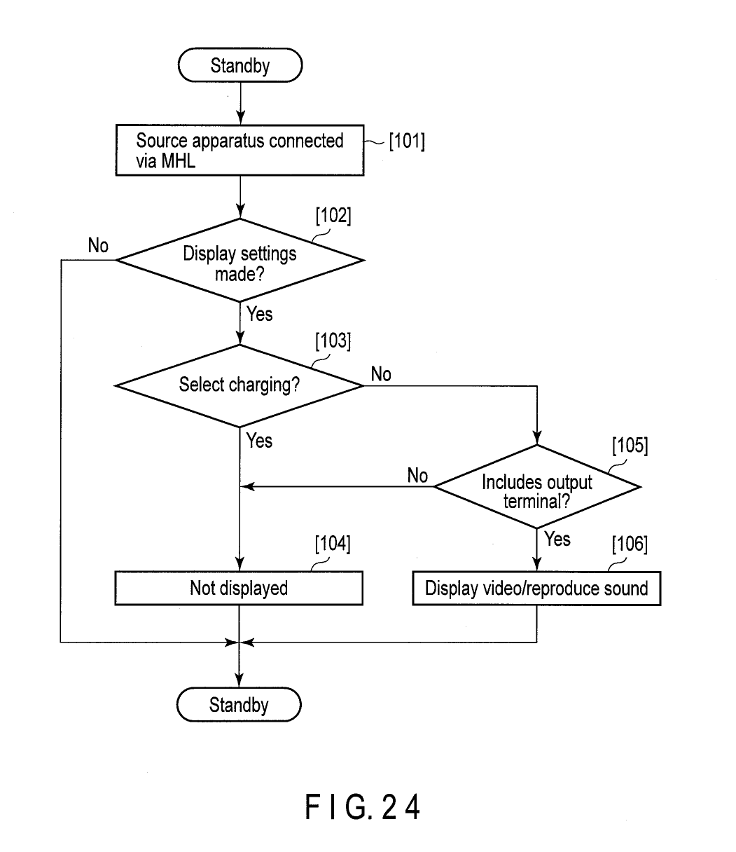

FIG. 24 illustrates settings for displaying, in the image receiving device 100, of an application being activated and video being reproduced on the side of the mobile terminal 200 when the mobile terminal 200 shown in FIG. 6 is connected to the image receiving device 100 via an MHL cable using the auto-menu shown in FIG. 7, in terms of software.

When the mobile terminal 200 is connected to the image receiving device 100 via an MHL cable [101], it is detected that display settings (auto-menu) have been made [102].

When the display settings (auto-menu) have been made [102—YES], (selection of) charging is detected [103].

When charging is selected [103—YES], “Do not display” is set, in which an application being activated or video being reproduced (and sound [audio] being reproduced) on the side of the mobile terminal 200 is not displayed on the side of the image receiving device 100 [104].

When charging is not selected [103—NO], it is detected that the device (mobile terminal) 200 is capable of outputting video/sound (includes an output device) [105].

When the device (mobile terminal) 200 is a device not including an output device for outputting video/sound [105—NO], it is determined that (selection of) charging has been made. That is, an output of a display or the like is not displayed [104].

When the device (mobile terminal) 200 is a device capable of outputting video/sound [105—YES], the mobile terminal 200 displays video being reproduced in or outputs an acoustic output to the image receiving device 100 [106].

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments. The accompanying claims and their equivalents are intended to cover such forms or modifications as would fall within the scope and spirit of the invention.

That is, according to the embodiment, it is possible to add “Set, in the sink apparatus (an output device or an image receiving device such as a TV), whether to output video being displayed by the source apparatus when the sink apparatus is connected to the source apparatus (such as a smartphone) via MHL”. Therefore, when a mobile terminal is connected to an image receiving device, it is possible to suppress an application being activated or video and speech output being reproduced in the mobile terminal from being output or reproduced without the intention of the owner (user) (it is possible to set an operation intended by the user at the time of connection).

Further, according to an embodiment, when an external device (source apparatus/smartphone) connected to an image receiving device is operated, it is possible to set whether to output video and speech of the external device (or not), and hence user-friendliness is improved.

Moreover, according to an embodiment, it is possible to suppress video and information of the source apparatus connected for the purpose of charging the battery, for example, from being immediately displayed in the sink apparatus.

In order to achieve the embodiment, the control module detects that power is supplied to a connected device (a connected device is charged) (by identifying (the type of) the mobile terminal on the basis of a MAC address).

Further, in order to achieve the embodiment, the control module receives a control instruction for not displaying the input video from a control instruction input module (button) displayed on the display (by allowing the user to select or determine a button) via a remote controller.

What is claimed is:

1. An electronic device comprising:
a display configured to display video;
a reception module configured to receive a video signal from a connected device; and
a controller configured to perform a display process of displaying input video corresponding to the video signal received by the reception module in the video being displayed by the display.

2. The electronic device of claim 1, wherein the controller configured to detect that power is supplied to the connected device.

3. The electronic device of claim 1, wherein the controller configured to receive a control instruction for not displaying the input video from a control instruction input module displayed on the display.

4. The electronic device of claim 3, wherein the controller configured to detect that a structure capable of outputting the input video does not exist in the connected device.

5. The electronic device of claim 2, wherein the controller configured to detect that a structure capable of outputting the input video does not exist in the connected device.

6. The electronic device of claim 1, further comprising:
a sound reproduction module configured to reproduce a sound.

7. The electronic device of claim 6, wherein the controller configured to detect that power is supplied to the connected device.

8. The electronic device of claim 6, wherein the controller configured to receive a control instruction for not reproducing the sound from a control instruction input module displayed by the display.

9. The electronic device of claim 6, wherein the controller configured to detect that a structure capable of outputting a sound to be reproduced does not exist in the connected device.

10. The electronic device of claim 8, wherein the controller configured to detect that a structure capable of outputting a sound to be reproduced does not exist in the connected device.

11. The electronic device of claim 7, wherein the controller configured to receive a control instruction for not displaying the input video from the control instruction input module displayed by the display.

12. The electronic device of claim 6, wherein the controller configured to receive a control instruction for not reproducing the sound from the control instruction input module displayed by the display.

13. The electronic device of claim 12, wherein the controller configured to detect that a structure capable of outputting a sound to be reproduced does not exist in the connected device.

14. An electronic device comprising:
a display configured to display video;
a transmission module configured to transmit a video signal to a connected electronic device; and
a controller configured to cause the connected electronic device to perform a reproduction process on the video signal transmitted by the transmission module.

15. The electronic device of claim 14, further comprising:
a power-supply configured to receive power from the connected electronic device,
wherein the controller configured to receive supply of the power from the connected electronic device to the power-supply.

16. The electronic device of claim 14, further comprising:
a sound reproduction module configured to reproduce sound corresponding to an acoustic signal.

17. The electronic device of claim 16, wherein the controller instruct the connected electronic device to perform a reproduction process on the acoustic signal transmitted by the transmission module.

18. A method for controlling an electronic device comprising:
receiving at least one of a video signal and an acoustic signal from a connected device; and
performing one of a process of not displaying the received video signal, a process of not displaying the received acoustic signal, or a process of not displaying the received video signal and not reproducing the received acoustic signal.

19. The method for controlling the electronic device of claim 18, wherein power is supplied to the connected device by referring to information unique to the connected electronic device.

20. The method for controlling the electronic device of claim 18, wherein a response to a control input is prohibited in the connected electronic device.
